(19) United States
(12) Patent Application Publication
(10) Pub. No.: US 2019/0012001 A1
(43) Pub. Date: Jan. 10, 2019

(54) Display Implementation Method and Apparatus, and Wearable Device

(71) Applicant: ZTE Corporation, Shenzhen (CN)

(72) Inventors: Baisheng ZHANG, Shenzhen (CN); Min FU, Shenzhen (CN)

(21) Appl. No.: 15/745,189

(22) PCT Filed: Oct. 30, 2015
(86) PCT No.: PCT/CN2015/093440

§ 371 Date: Jan. 16, 2018

(30) Foreign Application Priority Data
Jul. 24, 2015 (CN) 201510443008.X

(51) Int. Cl. G06F 3/0346; G06F 1/16

(52) U.S. Cl. CPC G06F 3/0346; G06F 2200/1637; G06F 2200/1614; G06F 1/163

(57) ABSTRACT

Provided are a display implementation method and apparatus, and a wearable device. In the method, a first angle and a second angle for determining a display region are acquired; and the display region for displaying information in correspondence to a current working mode is determined according to the obtained first angle and second angle.

### TECHNICAL FIELD

Embodiments of the present disclosure relate to wearable device technologies, and more particularly, to a display implementation method and apparatus and a wearable device.

### BACKGROUND

Wearable devices such as smart bracelets, smart watches and smart watchbands are becoming more and more popular. A smart watchband, for example, is provided to expand some functions, which cannot be included in a smart watch due to size limitations of the smart watch. Some wearable devices are not provided with display screens, and some wearable devices are provided with only one display screen on a watch face.

In order to enable a user to more conveniently and quickly see information, display expansion will be a development tendency. Moreover, soft screen technologies are quickly developed, and a flexible Light Emitting Diode (LED) screen will be quickly developed. These technologies bring feasible solutions to the expansion of display in the wearable devices.

At present, related display expansion solutions in the industry are as shown in FIG. 1 and FIG. 2. A segment of screen is embedded into a fixed position in a smart watchband. Thus, the position of displayed information is fixed in the watchband, and the information cannot be moved at will. To see information, a user needs to manually rotate the smart watchband to place the screen in front of the eyes of the user, so as to see the information displayed on the screen.

### SUMMARY

The following is a brief introduction for a subject matter described herein in detail. The brief introduction is not intended to restrict the scope of protection of claims.

Some embodiments of the present disclosure provide a display implementation method and apparatus, and a wearable device, which may be capable of conveniently and quickly displaying information on a wearable device.

An embodiment of the present disclosure provides a display implementation method. When there is information to be displayed, the method may include the acts as follows. A wearable device may acquire a first angle and a second angle for determining a display region.

The display region for displaying information in correspondence to a current working mode may be determined according to the obtained first angle and second angle.

In an embodiment, before the wearable device acquires the first angle and the second angle for determining the display region, the method may further include an act of calibrating the wearable device.

In an embodiment, the wearable device may be calibrated in a manner as follows.

A space coordinate system of the wearable device may be set up. Specifically, the space coordinate system may be set up by taking a first direction of a front surface of the wearable device as a y axis, taking a second direction of the front surface of the wearable device as an x axis, and taking an upward direction perpendicular to the front surface of the wearable device as a z axis.

A state in which the front surface of the wearable device points to a vertically upward direction may be taken as a space angle standard. An angle, measured in the state, between the x axis and a horizontal plane is 0 degrees, an angle, measured in the state, between the y axis and the horizontal plane is 0 degrees, and an angle, measured in the state, between the z axis and the horizontal plane is +90 degrees.

In an embodiment, the first angle may be the angle between the x axis and the horizontal plane.

The second angle may be the angle between the y axis and the horizontal plane.

In an embodiment, the working mode is a first working mode. The display region for displaying information may be determined in a manner as follows.

A pre-set first corresponding relationship between first and second angles and a display region may be searched according to the first angle and the second angle to determine the display region.

In an embodiment, the working mode is a second working mode. The display region for displaying information may be determined in a manner as follows.

A pre-set second corresponding relationship between first and second angles and a display region may be searched according to the first angle and the second angle to determine the display region.

In an embodiment, the method may further include an act of switching the working mode of the wearable device.

In an embodiment, the working mode may be switched in one of alternative manners as follows.

The wearable device may automatically switch between the first working mode and the second working mode according to time, and intensity of acceleration and angle variations detected by an acceleration sensor and a gyroscope.

Or, the wearable device may enter the first working mode or the second working mode based on manual setting selection.

In an embodiment, before switching the working mode, the method may further include an act of setting configuration information indicative of whether to switch between the first working mode and the second working mode.

Another embodiment of the present disclosure provides a display implementation apparatus, which may include an acquisition unit and a determination unit.

The acquisition unit may be configured to acquire a first angle and a second angle for determining a display region.

The determination unit may be configured to determine, according to the obtained first angle and second angle, the display region for displaying information in correspondence to a current working mode.

In an embodiment, the apparatus may further include a calibration unit configured to calibrate a wearable device.

In an embodiment, the calibration unit may be configured to:

set up a space coordinate system of the wearable device, wherein the space coordinate system may be set up by taking a first direction of a front surface of the wearable device as a y axis, taking a second direction of the front surface of the wearable device as an x axis, and taking an upward direction perpendicular to the front surface of the wearable device as a z axis; and

take a state in which the front surface of the wearable device points to a vertically upward direction as a space angle standard, wherein an angle, measured in the state, between the x axis and a horizontal plane is 0 degrees, an angle, measured in the state, between the y axis and the horizontal plane is 0 degrees, and an angle, measured in the state, between the z axis and the horizontal plane is +90 degrees.

In an embodiment, the first angle may be the angle between the x axis and the horizontal plane, and the second angle may be the angle between the y axis and the horizontal plane.

The determination unit may be configured to:

search, when the working mode is a first working mode, a pre-set first corresponding relationship between first and second angles and a display region according to the first angle and the second angle to determine the display region; and

search, when the working mode is a second working mode, a pre-set second corresponding relationship between first and second angles and a display region according to the first angle and the second angle to determine the display region.

In an embodiment, the apparatus may further include a working mode management unit configured to:

automatically switch, according to time, and intensity of acceleration and angle variations detected by an acceleration sensor and a gyroscope, the wearable device between the first working mode and the second working mode;

or, make the wearable device enter the first working mode or the second working mode based on manual setting selection.

In an embodiment, the working mode management unit may be further configured to set configuration information indicative of whether to automatically switch between different working modes.

Still another embodiment of the present disclosure provides a wearable device, including a display unit, and the apparatus as mentioned above.

In an embodiment, the display unit may be a 360° region surrounding the wearable device, or a segment of camber surface in the wearable device.

According to the solution of the present disclosure, a wearable device may acquire a first angle and a second angle for determining a display region; and the display region for displaying information in correspondence to a current working mode may be determined according to the obtained first angle and second angle. By means of the display implementation method based on a wearable device in some embodiments of the present disclosure, information can be conveniently and quickly displayed on the wearable device. The method can correctly and automatically display information needing to be displayed in front of the eyes of a user without the need for the user to manually adjust the position of a watchband to find the displayed information. For example, when the user raises the hand, visual information such as time information can be correctly displayed at a suitable position in front of the eyes of the user.

In some embodiments, the wearable device may also switch between different working modes, and enter the corresponding working mode according to user demands, thereby better ensuring the correctness of display implementation.

After the drawings and the detailed descriptions are read and understood, other aspects may be understood.

### BRIEF DESCRIPTION OF THE DRAWINGS

The drawings illustrated herein are intended to provide a deeper understanding for the present disclosure, and form a part of the present application. The schematic embodiments and illustrations of the present disclosure are intended to explain the present disclosure, and do not form improper limits to the present disclosure. In the drawings:

FIG. 1 is a schematic diagram of a first embodiment for display expansion in a wearable device;

FIG. 2 is a schematic diagram of a second embodiment for display expansion in a wearable device;

FIG. 3 is a flowchart of a display implementation method according to an embodiment of the present disclosure;

FIG. 4 is a schematic diagram of an embodiment for setting up a space coordinate system and dividing regions of a wearable device, e.g., a smart bracelet, according to an embodiment of the present disclosure; and

FIG. 5 is a composition structure diagram of a display implementation apparatus according to an embodiment of the present disclosure.

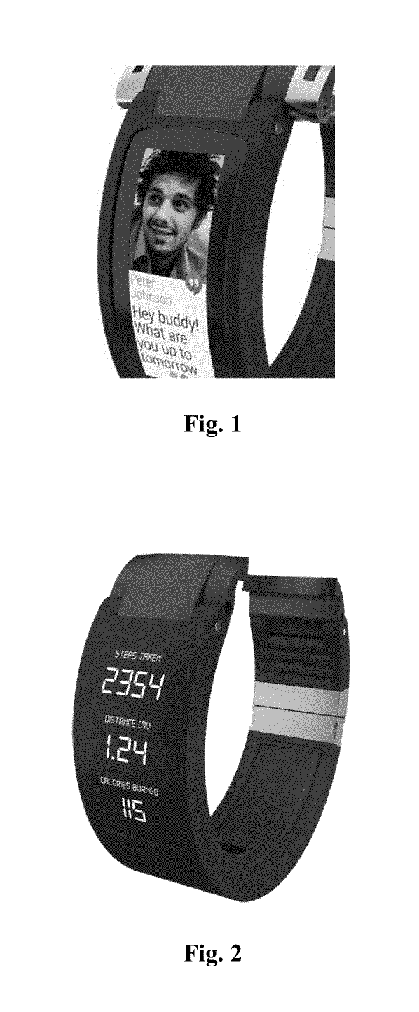

### DETAILED DESCRIPTION OF THE EMBODIMENTS

In order to make the aims, solutions and advantages of the present disclosure clearer, the embodiment of the present disclosure will be elaborated hereinbelow in conjunction with the drawings. It may be appreciated that embodiments in the present disclosure and features in the embodiments may be combined mutually under the condition of no conflicts.

As for a wearable device such as a smart bracelet and a smart watchband having a 360° display function or having a function of displaying via partial sections (i.e., not the 360° display) such as a segment of camber surface, some embodiments of the present disclosure will provide a method capable of correctly and automatically displaying information needing to be displayed in front of the eyes of a user without the need for the user to manually adjust the position of a watchband to find the displayed information. For example, when the user raises the hand, visual information such as time information can be correctly displayed at a suitable position in front of the eyes of the user.

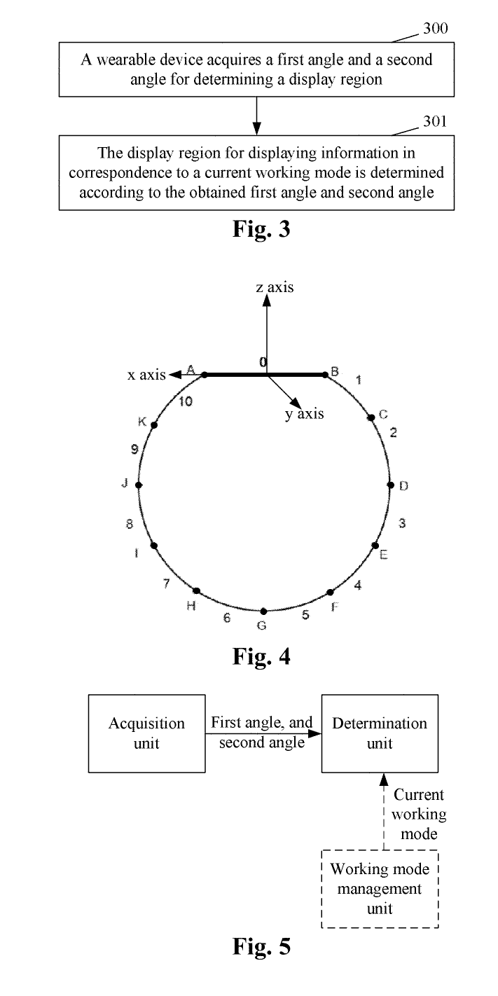

FIG. 3 is a flowchart of a display implementation method according to an embodiment of the present disclosure. As shown in FIG. 3, when there is information to be displayed, the method may include the acts as follows.

At act 300, a wearable device may acquire a first angle and a second angle for determining a display region.

FIG. 4 is a schematic diagram of an embodiment for setting up a space coordinate system and dividing regions of a wearable device, e.g., a smart bracelet, according to an embodiment of the present disclosure. As shown in FIG. 4, a space coordinate system may be set up by taking a first direction of a watch face such as a direction pointing at three o'clock as a y axis, taking a second direction of the watch face such as a direction pointing at six o'clock as an x axis and taking an upward direction perpendicular to the watch face as a z axis. It is supposed that a smart bracelet forms a circle by a watch face (thickened straight line segment AB as shown in FIG. 4) and a watchband (arc segment AB as shown in FIG. 4). The watchband may be equally divided into N segments (N>0). It is supposed that the segments are identified, if N=10, as 1, 2, 3, . . . , 10 respectively and the watch face is identified as 0. A central angle corresponding to the watch face is 60 degrees, and a central angle corresponding to each segment of arc of the watchband is 30 degrees. It may be appreciated that if a wearable device does not have a watch face, a space coordinate system may be set up by taking a central position of the wearable device such as a front surface of the wearable device as the watch face. A specific implementation manner may be easily implemented by those skilled in the art, and will not be elaborated herein.

In the present act, the first angle and the second angle may be obtained via a gyroscope or other angle sensors. A specific obtaining manner will not be illustrated in the embodiment of the present disclosure. The scope of protection of the embodiment of the present disclosure is not limited to any specific obtaining manner.

The first angle in the present act may be the angle between the x axis and the horizontal plane, and the second angle may be the angle between the y axis and the horizontal plane.

Before the wearable device acquires the first angle and the second angle for determining the display region, the method in the embodiment of the present disclosure may further include the act as follows.

The wearable device may be calibrated. A state in which the front surface of the wearable device points to a vertically upward direction may be taken as a space angle standard. An angle, measured in the state by e.g., the gyroscope or other angle sensors, between the x axis and a horizontal plane is 0 degrees, an angle, measured in the state by e.g., the gyroscope or other angle sensors, between the y axis and the horizontal plane is 0 degrees, and an angle, measured in the state by e.g., the gyroscope or other angle sensors, between the z axis and the horizontal plane is 90 degrees. Specifically, the wearable device may be adjusted by making the watch face or a bracelet screen point to a vertically upward direction, i.e., adjusting an angle between the x axis and the horizontal plane to be 0 degrees, adjusting an angle between the y axis and the horizontal plane to be 0 degrees, and adjusting an angle between the z axis and the horizontal plane to be +90 degrees. Specific calibration for the wearable device may be completed before delivery of the product. A specific calibration manner is an idiomatic means of those skilled in the art, and is not intended to limit the scope of protection of the embodiment of the present disclosure. The calibration is suggested to be performed in order to achieve the above space angle standard.

At act 301, the display region for displaying information in correspondence to a current working mode may be determined according to the obtained first angle and second angle.

Working modes of the wearable device may be obtained. For example, different identifiers may be set in correspondence to different working modes to distinguish the working modes.

In the present act, the working modes of the wearable device may include a first working mode and a second working mode.

The first working mode is that a user wearing the wearable device is standing or sitting. As an example, the user may wear a watch on the left hand by convention. Under such a circumstance, an angle between the y axis and the horizontal plane when the arm sags naturally is about (−90±15) degrees. When an absolute value exceeds 90 degrees, a supplementary angle thereof may be adopted to serve as the angle between the y axis and the horizontal plane when the arm sags naturally, and a symbol is kept. When the angle between the y axis and the horizontal plane exceeds ±30 degrees, the device may be screened off automatically, and a watchband does not display information.

Under such a circumstance, when wanting to look at the watch, the user raises the arm. According to a watch looking habit, an angle between the sight and the horizontal plane may be about (−30±5) degrees. When the angle between the y axis and the horizontal plane is smaller than or equal to 30 degrees, a pre-set first corresponding relationship between first and second angles and a display region may be searched according to the angle between the x axis and the horizontal plane and the angle between the z axis and the horizontal plane to determine a display region of the watch face or the watchband for displaying information. After determining the display region, the information may be displayed on the display region. Taking FIG. 4 as an example, the first corresponding relationship may be shown in the following Table 1:

TABLE 1

| Angle (degree) | Angle (degree) | |
|---|---|---|
| between X axis | between Z axis | Display |
| and horizontal plane | and horizontal plane | region |
| 0 ± 15 | 90 ± 15 | 1 |
| 30 ± 15 | 60 ± 15 | 2 |
| 60 ± 15 | 30 ± 15 | 3 |
| 90 ± 15 | 0 ± 15 | 4 |
| 60 ± 15 | −30 ± 15 | 5 |
| 30 ± 15 | −60 ± 15 | 6 |
| 0 ± 15 | −90 ± 15 | 7 |
| −30 ± 15 | −60 ± 15 | 8 |
| −60 ± 15 | −30 ± 15 | 9 |
| −90 ± 15 | 0 ± 15 | 10 |
| −60 ± 15 | 30 ± 15 | 0 |
| −30 ± 15 | 60 ± 15 | 0 |

The second working mode is that a user wearing the wearable device is lying, and is looking at the watch with a vertically upward sight. Under such a circumstance, an angle between the sight and the horizontal plane is about (90±15) degrees. When an absolute value exceeds 90 degrees, a supplementary angle thereof may be adopted to serve as the angle between the sight and the horizontal plane, and a symbol is kept. A pre-set second corresponding relationship between first and second angles and a display region may be searched according to the angle between the x axis and the horizontal plane and the angle between the z axis and the horizontal plane to determine a certain region of the watch face or the watchband for displaying information. After determining the display region, the information may be displayed on the display region. Taking FIG. 4 as an example, the second corresponding relationship may be shown in the following Table 2:

TABLE 2

| Angle (degree) | Angle (degree) | |
|---|---|---|
| between X axis | between Z axis | Display |
| and horizontal plane | and horizontal plane | region |
| 15 ± 15 | −75 ± 15 | 0 |
| 45 ± 15 | −45 ± 15 | 1 |
| 75 ± 15 | −15 ± 15 | 2 |
| 75 ± 15 | 15 ± 15 | 3 |
| 45 ± 15 | 45 ± 15 | 4 |
| 15 ± 15 | 75 ± 15 | 5 |
| 0 ± 15 | 75 ± 15 | 6 |
| −15 ± 15 | 45 ± 15 | 7 |
| −45 ± 15 | 15 ± 15 | 8 |
| −75 ± 15 | −15 ± 15 | 9 |
| −45 ± 15 | −45 ± 15 | 10 |
| −15 ± 15 | −75 ± 15 | 0 |

It may be appreciated that specific values in Table 1 and Table 2 are for illustration only, and are not intended to limit the scope of protection of the embodiments of the present disclosure. The specific values may be correspondingly adjusted according to practical usage situations such as wearing on the right hand and a finger or serving as glasses. Moreover, according to the above-mentioned solution provided in the embodiment of the present disclosure, this adjustment is implementable to those skilled in the art.

By adopting the method in the embodiments of the present disclosure, when taking a subway or bus, driving a car or walking, if wanting to check time or other information, a user wearing a wearable device may raise the wrist to directly check the information. Moreover, when waking up at night, the user can directly raise the wrist to check watch information without the need of rotating a watch face (the action of rotating the watch face may reduce sleepiness) to find a display surface, and therefore the influence on sleep quality is also avoided.

By means of the display implementation method based on the wearable device in the embodiments of the present disclosure, information can be conveniently and quickly displayed on the wearable device. The method can correctly and automatically display information needing to be displayed in front of the eyes of a user without the need for the user to manually adjust the position of a watchband to find the displayed information. For example, when the user raises the hand, visual information such as time information can be correctly displayed at a suitable position in front of the eyes of the user.

The method in the embodiment of the present disclosure may further include an act of switching the working mode of the wearable device.

According to internal time, and intensity of acceleration and angle variations detected by an acceleration sensor and a gyroscope, the wearable device may automatically switch between the first working mode and the second working mode. For example, the intensity of acceleration and angle variations may be set as follows. The variations may be deemed to be intense when the acceleration is greater than 0.1 g, where g is an acceleration of gravity. The angles between the three axes and the horizontal plane may be read at an interval of 12s, the sum of absolute values of a difference between two successive angles of each axis may be marked as an angle increment, and the variations may be deemed to be intense when the angle increment within one minute is greater than 10 degrees and lasts for 3 minutes.

For example, when the internal time of the device is p.m. 22:00 to a.m. 5:00, if the acceleration sensor and the gyroscope do not sense continuous variations for a long time (such as pre-set ten minutes or other values) or are within a certain pre-set threshold, for example, the angle increment within 3 minutes is smaller than 10 degrees, and the acceleration is smaller than 0.1 g, where g is the acceleration of gravity, the wearable device may automatically switch from the first working mode to the second working mode.

For another example, when the internal time of the device is a.m. 10:00 to p.m. 18:00, the wearable device may automatically switch to the first working mode no matter whether the acceleration sensor and the gyroscope detect the variations.

Or, a current working mode may be manually set as one of the above two working modes. For example, the user may select to make the wearable device enter the first working mode or the second working mode by using one or more keys around the watch face of the watch.

The method in the embodiment of the present disclosure may further include an act of selecting, via setting, configuration information indicative of whether to be capable of automatically switching between different working modes. If the setting is yes, the wearable device will automatically switch between the first working mode and the second working mode according to time, and intensity of acceleration and angle variations detected by the acceleration sensor and the gyroscope.

In the embodiment of the present disclosure, the wearable device may enter the corresponding working mode according to user demands, thereby better ensuring the correctness of display implementation.

FIG. 5 is a composition structure diagram of a display implementation apparatus according to an embodiment of the present disclosure. As shown in FIG. 5, the apparatus may include an acquisition unit and a determination unit.

The acquisition unit may be configured to acquire a first angle and a second angle for determining a display region.

The determination unit may be configured to determine, according to the obtained first angle and second angle, the display region for displaying information in correspondence to a current working mode.

The apparatus in the embodiment of the present disclosure may further include a calibration unit (not shown in FIG. 5), configured to calibrate a wearable device. A space coordinate system of the wearable device may be set up. Specifically, the space coordinate system may be set up by taking a first direction of a front surface of the wearable device as a y axis, taking a second direction of the front surface of the wearable device as an x axis, and taking an upward direction perpendicular to the front surface of the wearable device as a z axis. A state in which the front surface of the wearable device points to a vertically upward direction may be taken as a space angle standard, wherein an angle, tested by a gyroscope or other angle sensors in the state, between the x axis and a horizontal plane is 0 degrees, an angle, tested by a gyroscope or other angle sensors in the state, between the y axis and the horizontal plane is 0 degrees, and an angle, tested by a gyroscope or other angle sensors in the state, between the z axis and the horizontal plane is 90 degrees. During practical application, the gyroscope, an acceleration sensor and setup of the coordinate system may be performed on the basis of data calibrated by the calibration unit.

Herein, the first angle may be the angle between the x axis and the horizontal plane, and the second angle may be the angle between the y axis and the horizontal plane. The determination unit may be configured to:

search, when the working mode is a first working mode, a pre-set first corresponding relationship between first and second angles and a display region according to the first angle and the second angle to determine the display region; and search, when the working mode is a second working mode, a pre-set second corresponding relationship between first and second angles and a display region according to the first angle and the second angle to determine the display region.

The apparatus in the embodiment of the present disclosure may further include a working mode management unit configured to switch the working mode, and configured to:

automatically switch, according to time, and intensity of acceleration and angle variations detected by the acceleration sensor and the gyroscope, the wearable device between the first working mode and the second working mode;

or, make the wearable device enter the first working mode or the second working mode based on manual setting selection.

The working mode management unit may be further configured to set configuration information indicative of whether to be capable of automatically switching between different working modes.

The display implementation apparatus of the embodiment of the present disclosure as shown in FIG. 5 may independently serve as an entity, or may be arranged in a wearable device. In this case, the wearable device may include a display unit and the display implementation apparatus of the embodiments of the present disclosure. The display unit may be a 360° region surrounding the wearable device, or may be a segment of camber surface in the wearable device.

The above is only the exemplary embodiments of the present disclosure, and not intended to limit the scope of protection of the present disclosure. Any modifications, equivalent replacements, improvements and the like made within the principle of the present disclosure shall fall within the scope of protection defined by the appended claims of the present disclosure.

### INDUSTRIAL APPLICABILITY

The embodiments of the present disclosure provide a display implementation method and apparatus, and a wearable device. In the method, a wearable device may acquire a first angle and a second angle for determining a display region; and the display region for displaying information in correspondence to a current working mode may be determined according to the obtained first angle and second angle. By means of the display implementation method based on the wearable device in some embodiments of the present disclosure, information can be conveniently and quickly displayed on the wearable device. The method may correctly and automatically display information needing to be displayed in front of the eyes of a user without the need for the user to manually adjust the position of a watchband to find the displayed information. For example, when the user raises the hand, visual information such as time information can be correctly displayed at a suitable position in front of the eyes of the user.

1. A display implementation method, when there is information to be displayed, the method comprising:
acquiring, by a wearable device, a first angle and a second angle for determining a display region; and
determining, according to the obtained first angle and second angle, the display region for displaying information in correspondence to a current working mode.

2. The method as claimed in claim 1, before acquiring, by a wearable device, a first angle and a second angle for determining a display region, the method further comprising:
calibrating the wearable device.

3. The method as claimed in claim 2, wherein calibrating the wearable device comprises:
setting up a space coordinate system of the wearable device, wherein the space coordinate system is set up by taking a first direction of a front surface of the wearable device as a y axis, taking a second direction of the front surface of the wearable device as an x axis, and taking an upward direction perpendicular to the front surface of the wearable device as a z axis; and
taking a state in which the front surface of the wearable device points to a vertically upward direction as a space angle standard, wherein an angle, measured in the state, between the x axis and a horizontal plane is 0 degrees, an angle, measured in the state, between the y axis and the horizontal plane is 0 degrees, and an angle, measured in the state, between the z axis and the horizontal plane is +90 degrees.

4. The method as claimed in claim 3, wherein
the first angle is the angle between the x axis and the horizontal plane; and
the second angle is the angle between the y axis and the horizontal plane.

5. The method as claimed in claim 3, wherein
the working mode is a first working mode, and determining the display region for displaying information comprises:
searching, according to the first angle and the second angle, a pre-set first corresponding relationship between first and second angles and a display region to determine the display region; or
the working mode is a second working mode, and determining the display region for displaying information comprises:
searching, according to the first angle and the second angle, a pre-set second corresponding relationship between first and second angles and a display region to determine the display region.

6. The method as claimed in claim 5, further comprising:
switching the working mode of the wearable device.

7. The method as claimed in claim 6, wherein switching the working mode comprises:
automatically switching, by the wearable device according to time, and intensity of acceleration and angle variations detected by an acceleration sensor and a gyroscope, between the first working mode and the second working mode;
or, entering, by the wearable device, the first working mode or the second working mode based on manual setting selection.

8. The method as claimed in claim 7, before switching the working mode, the method further comprising:
setting configuration information indicative of whether to switch between the first working mode and the second working mode.

9. A display implementation apparatus comprising an acquisition unit and a determination unit, wherein
the acquisition unit is configured to acquire a first angle and a second angle for determining a display region; and
the determination unit is configured to determine, according to the obtained first angle and second angle, the display region for displaying information in correspondence to a current working mode.

10. The apparatus as claimed in claim 9, further comprising a calibration unit, configured to calibrate a wearable device.

11. The apparatus as claimed in claim 10, wherein the calibration unit is configured to:
set up a space coordinate system of the wearable device, wherein the space coordinate system is set up by taking a first direction of a front surface of the wearable device as a y axis, taking a second direction of the front surface of the wearable device as an x axis, and taking an upward direction perpendicular to the front surface of the wearable device as a z axis; and
take a state in which the front surface of the wearable device points to a vertically upward direction as a space angle standard, wherein an angle, measured in the state, between the x axis and a horizontal plane is 0 degrees, an angle, measured in the state, between the y axis and the horizontal plane is 0 degrees, and an angle, measured in the state, between the z axis and the horizontal plane is +90 degrees.

12. The apparatus as claimed in claim 11, wherein the first angle is the angle between the x axis and the horizontal plane, and the second angle is the angle between the y axis and the horizontal plane.

13. (canceled)

14. (canceled)

15. A wearable device, comprising a display unit, and the apparatus as claimed in claim 9.

16. The wearable device as claimed in claim 15, wherein the display unit is a 360° region surrounding the wearable device, or a segment of camber surface in the wearable device.

17. A computer-readable storage medium, storing a computer-executable instruction, wherein the computer-executable instruction is configured to execute the method as claimed in claim 1.

18. The apparatus as claimed in claim 11, wherein the determination unit is configured to:
search, when the working mode is a first working mode, a pre-set first corresponding relationship between first and second angles and a display region according to the first angle and the second angle to determine the display region; and
search, when the working mode is a second working mode, a pre-set second corresponding relationship between first and second angles and a display region according to the first angle and the second angle to determine the display region.

19. The apparatus as claimed in claim 18, further comprising a working mode management unit, configured to switch the working mode of the wearable device.

20. The apparatus as claimed in claim 19, wherein the working mode management unit is configured to:
automatically switch, according to time, and intensity of acceleration and angle variations detected by an acceleration sensor and a gyroscope, the wearable device between the first working mode and the second working mode;
or, make the wearable device enter the first working mode or the second working mode based on manual setting selection.

21. The apparatus as claimed in claim 20, wherein the working mode management unit is further configured to: set configuration information indicative of whether to automatically switch between different working modes.

22. The method as claimed in claim 3, wherein the front surface of the wearable device is a watch face of the wearable device, or a central position of the wearable device.
